(19) United States
(12) Patent Application Publication
(10) Pub. No.: US 2023/0098379 A1
(43) Pub. Date: Mar. 30, 2023

(54) SYSTEM AND METHOD FOR DEVELOPING MACHINE LEARNING MODELS FOR TESTING AND MEASUREMENT

(71) Applicant: Tektronix, Inc., Beaverton, OR (US)

(72) Inventors: Mark Anderson Smith, Portland, OR (US); Sunil Mahawar, Portland, OR (US); John J. Pickerd, Hillsboro, OR (US); Sriram K. Mandyam, Bengaluru (IN)

(73) Assignee: Tektronix, Inc., Beaverton, OR (US)

(21) Appl. No.: 17/951,064

(22) Filed: Sep. 22, 2022

(30) Foreign Application Priority Data
Sep. 29, 2021 (IN) 202121044150

(51) Int. Cl. G06N 20/00; G06K 9/62; G06N 3/02

(52) U.S. Cl. CPC G06N 20/00; G06K 9/6256; G06N 3/02

(57) ABSTRACT

A test and measurement machine learning model development system includes a user interface, one or more ports to allow the system to connect to one or more data sources, one or more memories, and one or more processors configured to execute code to cause the one or more processors to: display on the user interface one or more application user interfaces, the application user interfaces to allow a user to provide user inputs; use and application programming interface to configure the system based on the user inputs; receive data from the one or more data sources; apply one or more modules from a library of signal processing and feature extraction modules to the data to produce training data; apply one or more machine learning models to the training data; provide monitoring of the one or more machine learning models; and save the one or more machine learning models to at least one of the one or more memories. A method for operating a machine learning model development system includes displaying, on a user interface, one or more application user interfaces, the application user interfaces allowing a user to provide user inputs, configuring the system based on the user inputs through an application programming interface, receiving data from one or more data sources, applying one or more modules from a library of signal processing and feature extraction modules to the data to produce training data, applying one or more machine learning models to the training data, providing monitoring of the one or more machine learning models, and saving the one or more machine learning models to at least one of the one or more memories.

### CROSS-REFERENCE TO RELATED APPLICATIONS

This disclosure claims benefit of Indian Provisional Patent Application No. 202121044150, titled SYSTEM AND METHOD FOR DEVELOPING MACHINE LEARNING MODELS FOR TESTING AND MEASUREMENT, filed Sep. 29, 2021, the disclosure of which is incorporated herein by reference in its entirety.

### TECHNICAL FIELD

The present disclosure relates generally to testing of electronic devices and specifically to systems and methods for developing machine learning models for testing and measurement of electronic devices.

### BACKGROUND

Testing and measurement of electronic devices produces testing data, which may be useful in developing machine learning (ML) models. Generally, testing and measurement research and development groups, such as a manufacturer of test and measurement systems, instruments, and/or applications, do not have ready access to testing data from customers or users. Similarly, customers may not have access to easy to use or readily deployable toolkits for developing their own machine learning models. No specific or readily available tools exist to develop fast experimentation tools for deployment of developed machine learning models.

In addition, machine learning for time series data may not perform well using raw data inputs. Machine learning models require specific tools to identify quickly what feature extraction methods work best, but most users do not have them readily available. Different environments or different machine learning stacks cannot easily re-use prior developed machine learning models. Developing machine learning products deployable to all environments becomes cumbersome and expensive. Often, user requirements lead to customized machine learning products.

### BRIEF DESCRIPTION OF ACCOMPANYING DRAWINGS

FIG. 1 shows an embodiment a machine learning model development system in a test and measurement environment.

FIG. 2 shows an embodiment of a machine learning model development system with external data sources.

FIG. 3 shows an embodiment of a machine learning model development system with an internal data management and feature store.

FIG. 4 shows an embodiment of a machine learning model development system in a runtime environment.

FIG. 5 shows an embodiment of a machine learning model development system in a runtime environment using an Open Neural Network Exchange (ONNX).

### DETAILED DESCRIPTION

A need exists for an effective machine learning modeling system that overcomes the above-cited problems by enabling faster machine learning training, experimentation, and prototyping for test and measurement systems, instruments, and applications. A further need exists for a re-usable execution model in the machine learning modeling system to become part of a library of potential models usable in a variety of system applications like oscilloscopes, automation tools, cloud, etc.

The various embodiments of the present disclosure provide a machine learning model development system and architecture that enables development of machine learning models for use in test and measurement systems. The machine learning model development system enables faster prototyping, state of art research and production. Further, the modeling system includes a re-usable execution model that creates a library in system applications like oscilloscopes, automation tools, cloud, etc.

The embodiments provide a machine learning model development system that enables development of machine learning models for test and measurement systems. The machine learning modeling system disclosed comprises a significant improvement over conventional architectures, and enables faster machine learning training, experimentation, and prototyping of test and measurement instruments.

As used here, the term “machine learning model” or “model” refers to a program or program file that contains code executable by processors. One or more processors execute the code to analyze a dataset and provide answers or inferences, typically in the form of identified patterns or predictive answers or recommendations. The model may take the form of a neural network, but may also comprise other types of machine learning models, such as decision trees, as an example. The term “module” as used here means a set of executable code that causes the one or more processors to perform specific operations on the data.

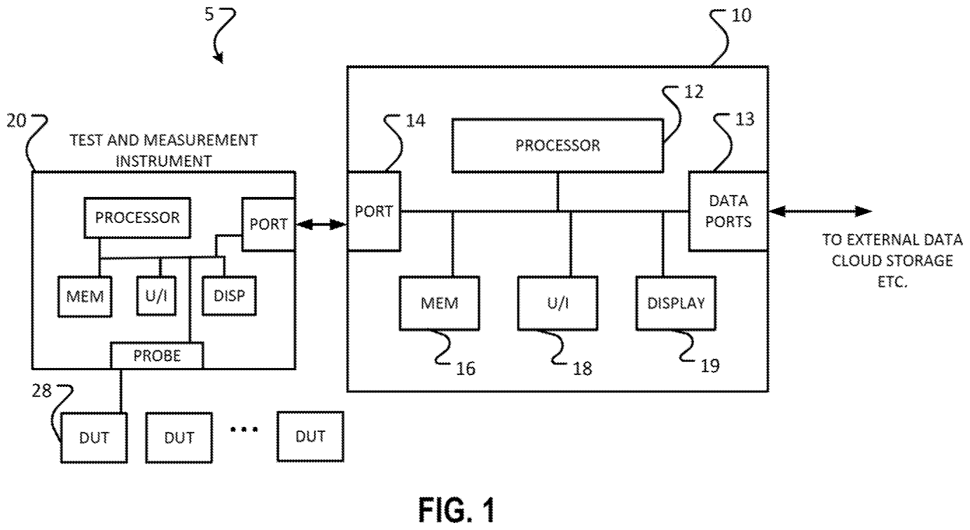

FIG. 1 shows an embodiment of a test and measurement machine learning model development system 10 in the context of a test and measurement system 5. In some embodiments, the machine learning model development system 10 may reside on a device, such as a computing device, connected to one or more test and measurement instruments 20, such as oscilloscopes, bit error rate testers (BERT), multi-meters, spectrum analyzers, etc. The test and measurement instrument 20 may be connected to a device under test (DUT) 28 and measure signals from the DUT to obtain testing data. In some test and measurement systems, such as on a manufacturing line, the test and measurement instrument 20 may test multiple DUTs to obtain a large population of testing data. However, the machine learning model development system 10 does not necessarily depend upon a connection to a test and measurement instrument 20 for testing data, as discussed further below. Further, as technology continues to advance, the machine learning model development system 10 may reside within the test and measurement instrument 20 itself.

The machine learning model development system 10 may include one or more processors 12 that communicate with one or more test and measurement instruments 20 through one or more ports 14. This port may comprise a wireless of wired/cabled port combined with drivers for multiple test and measurement instruments that allow the system to set up and run test on a device under test (DUT). The port 14 may include ports to communicate with other devices, remote storage, etc. Alternatively, another data port 13 may provide that access, where that access may include external data sources as discussed in more detail below.

The machine learning model development system 10 may also include one or more data repositories, represented by the memory 16. The user interacts with the machine learning model development system through a user interface 18 and/or a display 19. In some embodiments, the user interface 18 includes a display. This allows the user to make selections that allow the user to configure, test, and monitor the machine learning model being developed. The test and measurement instrument 20 has similar components to the machine learning model development system 10. In some embodiments the machine learning model development system 10 and the test and measurement instrument 20 may be the same physical device, as mentioned previously.

The one or more processors 12 may be configured to execute code that causes the processors to implement the methods and systems of the embodiments. The devices may distribute the processing tasks across both devices, as well as other devices such as those involved in cloud storage.

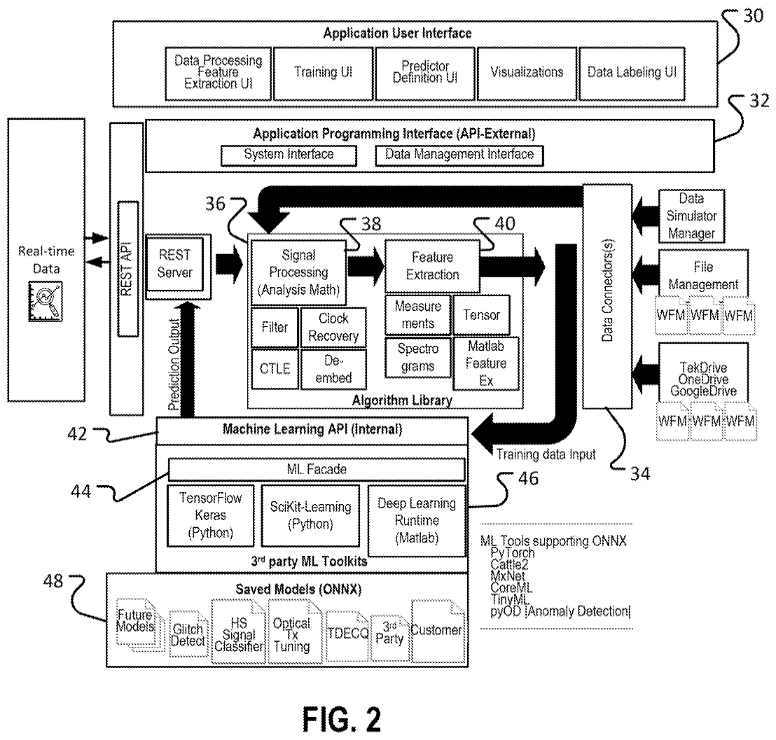

FIG. 2 shows an embodiment of a machine learning model development system, such as machine learning model development system 10, incorporating external data sources. An Application User Interface 30 interacts with the system through an Application Programming Interface (API) 32 system boundary. The Application User Interface 30 allows the user to provide user inputs. These user inputs are then used to configure various components of the machine learning model development system through the API 32. The API 32 allows use of different Application User Interface frameworks and the ability to change frameworks easily over time. In one embodiment, the Application User Interface may contain a data processing and feature extraction UI, a training UI, a predictor definition UI, visualizations UI, and a data labeling UI. The data processing and feature extraction UI allows the user to define what features of the data they want to extract for modeling, as well as any signal processing to apply to the data. The training UI allows the user to monitor the progress and quality of the training. This may include real-time monitoring tools on training of the models, and model execution. This will help users such as engineers and data scientists to further fine tune the models deployed on the machine learning runtime, or an experimental runtime. The predictor definition UI provides a dashboard for runtime predictions. The visualizations UI allows the user to set up and see visual representation of the data and the progress of the training. The data labeling UI provides an annotator or labeling tool for the customers to annotate or label the data. This seamlessly integrates into a database or data lake as defined by the user. A data lake generally comprises a repository of all the data, whether structured, unstructured or semi-structured.

The API may contain a system interface and a data management interface. The API enables transfer of information and data between the user and various components of the machine learning model development system. For example, the system interface may provide settings and configuration data derived from user inputs to the various modules and the data management interface may operate on the data from the external sources. The machine learning model development system also contains a general data connector subsystem 34 to enable receiving data from a variety of sources. The data inputs through the data connector could come from a variety of sources including a database, data/waveform simulation tool, general-purpose waveform files, acquisition data directly from an instrument or cloud sources such as TekDrive. In one embodiment, the Data Connector enables transfer of data from a Data Simulator Manager, a File Management Manager, automation tools, and/or cloud sources Google Drive, OneDrive, TekDrive, etc.

The system transfers data from the data connector 34 to a library 36 of modules that selectively operate on the data in several ways. In the embodiments here, the library comprises two groups of modules. One should note that these two groups could comprise one large group of modules or be grouped differently, and may contain more or fewer modules, or different modules than the examples discussed below.

A signal processing group 38 provides options for signal processing and mathematical analysis of the data. The modules in this group may include a filter module, a clock recovery module, a Continuous Time Linear Equalization (CTLE) module, and a De-embed module, as examples. The data inputs from variety of sources are transferred through the data connector to the signal processing module. The signal processing module may also process real-time data received via a REST API and a REST Server. The REST API is a language-agnostic API that enables one of the system applications like an automation tool to supply data for prediction and query for prediction results.

The second group of modules in this embodiment comprises a feature extraction group 40. The feature extraction group 40 generally transforms the raw data into the numerical features for input to, and processing, by the machine learning models. These modules may include a measurements module, a tensor building module, a spectrograms module, and a MATLAB feature extraction module, as examples. Raw waveform time series data is not typically amenable to autoencoder or other automatic classification systems. Training models using raw acquisition data also typically yields less accurate results due to high sample rate/data redundancy.

These two groups 38, 40 provide developer users considerable flexibility in choosing signal processing and feature extraction methodologies for effective machine learning model development. The flexibility provided by the signal processing modules and feature extraction modules improves classification and experimentation to help achieve the most accurate prediction results possible. The library 36 takes specific data inputs and may provide one or more training datasets to a Machine Learning API 42.

The Machine Learning API 42 allows the system to provide processed training data from the library 36 to one of many different machine learning toolkits 46. This may include multiple machine learning toolkits such as Deep Learning Runtime for MATLAB, TensorFlow for Python, TensorFlow with the Keras API, SciKit-Learning for Python, among many others. The machine learning toolkits 46 may also be referred to as machine learning libraries, frameworks, platforms, programming languages, ecosystems, or environments. This provides a technology agnostic machine learning system, not limited to any specific technology. The Machine Learning API 42 maps to the specific toolkits' APIs through a facade layer 44. The term facade, or facade layer, generally means a simplified interface to a more complex underlying structure, such as a framework or library, as in this system. The multi-technology aspect of the embodiments allows extension of the system to machine learning algorithms and classification systems other than neural networks, such as decision trees, etc. The user can develop a new machine learning model using one of the machine learning toolkits through the machine learning API 42.

Similarly, the machine learning API 42 and/or the machine learning toolkits 46 can utilize one of several different saved machine learning models from the saved model library 48. These may include, but are not limited to, a trained machine learning model for performing glitch detection, a trained machine learning model for performing high speed signal classification, a trained machine learning model for performing tuning of optical transceivers, and a trained machine learning model for performing Transmitter Distortion and Eye Closure Quaternary (TDECQ) measurements, third party models, and customer developed and provided models. For example, models resulting from this development system could be stored here for later use.

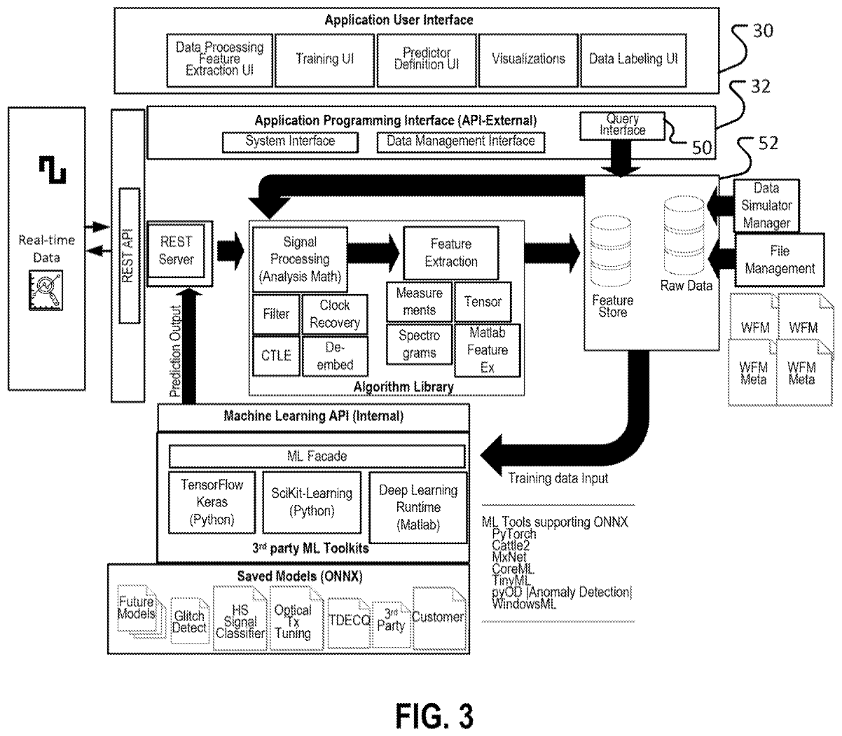

FIG. 3 shows an embodiment of a machine learning model development system, with a data management subsystem 52. In this embodiment, the data system may include an embedded database, and/or connectivity to a cloud data lake system, enabling large dataset storage. The API 32 includes a query interface 50 in this embodiment. This also enables more sophisticated data access, labeling, normalization, and query systems. It supports validation queries and visualization graphs using standardized query languages. The data system may reside on premises, or remote. The search tools provided allow engineers and data scientists to perform exploratory analysis, search for structured, unstructured, and semi-structured data. The data may include binary data like waveforms, text data like log files, telemetry information, and semi-structured data like measurement results. These merely provide examples of types of data, without limitation.

In addition to the data store, the data management system 52 can also include a feature store to provide feature extracted data to models. The feature store de-couples the raw data from the feature set, allowing the ‘same’ feature extraction to be used for different data. This facilitates re-use and experimentation across different feature extractions and their impact on predictive accuracy of the models.

Both FIG. 2 and FIG. 3 show the use of ONNX (Open Neural Network Exchange). The ONNX standard provides a means to standardize machine learning model files. This file format has broad support and a rich development eco-system. ONNX files define a neural network definition, currently supported by many machine learning environments such as MATLAB, PyTorch, TensorFlow, and others. GPU environments also support the format, enabling further accelerated machine learning workflows. This contributes to the overall flexibility and technology agnostic characteristics of the overall system.

Similar to the technology-agnostic nature of the system, the system has the capability to separate out the runtime elements into a standard library suite for re-use in other applications. These may include embedded instrument use, automation and solutions, and transferrable to cloud environments. This capability combined with using ONNX file supports allows for development of trained models in one environment, transfer and use of those models in other environments. This also provides support for the development of pre-trained models for sale or distribution to customers.

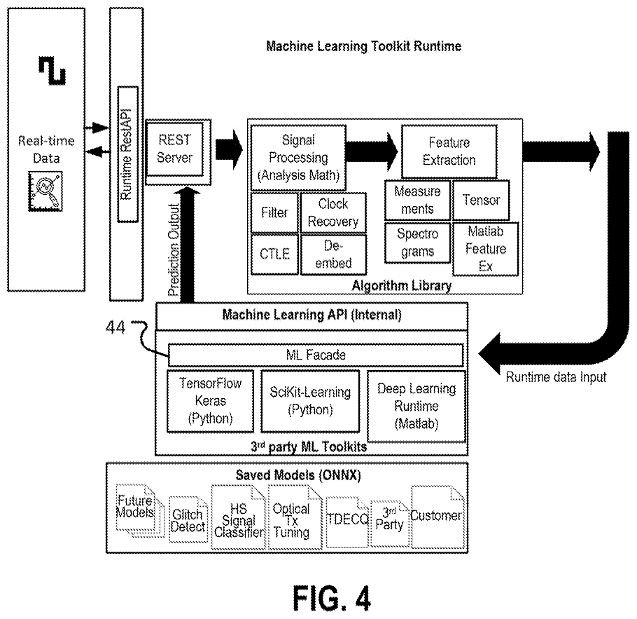

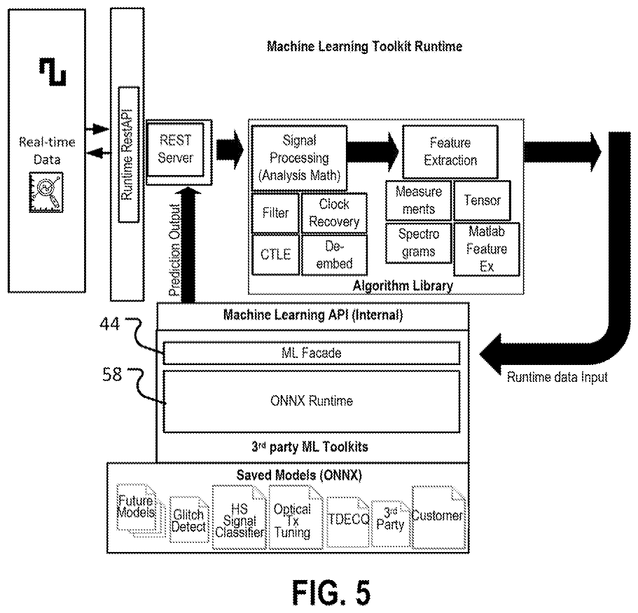

FIGS. 4 and 5 show two different embodiments of the machine learning model development system at runtime. FIG. 4 shows a first embodiment in which a general machine learning facade 44 communicates with specific machine learning toolkits. One should note that the Application User Interface 30 and the API 32 from FIGS. 2-3 may not be present in this environment. FIG. 5 shows an embodiment in which the machine learning libraries employ the ONNX runtime file format 58.

The embodiments here provide a simple interface to a user to develop machine learning solutions for testing and measurement domain, that are reusable, robust and that can be readily deployed. The embodiments provide a machine learning model development system that effectively stores and manages learning datasets. The embodiments provide an execution model as part of the ML model development system to be effectively re-used as a library in a variety of system applications like oscilloscopes, automation tools, cloud, etc. The embodiments further provide a machine learning model development system that has feedback to the system that enables continuous learning, enables faster testing and measurement, and has signal processing and feature extraction methods to increase the prediction accuracy of developed machine learning models.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Graphics Processing Units (GPUs), Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

### EXAMPLES

Illustrative examples of the disclosed technologies are provided below. An embodiment of the technologies may include one or more, and any combination of, the examples described below.

Example 1 is test and measurement machine learning model development system, the system comprising: a user interface; one or more ports to allow the system to connect to one or more data sources; one or more memories; and one or more processors configured to execute code to cause the one or more processors to: display on the user interface one or more application user interfaces, the application user interfaces to allow a user to provide user inputs; use an application programming interface to configure the system based on the user inputs; receive data from the one or more data sources; apply one or more modules from a library of signal processing and feature extraction modules to the data to produce training data; apply one or more machine learning models to the training data; provide monitoring of the one or more machine learning models; and save the one or more machine learning models to at least one of the one or more memories.

Example 2 is the test and measurement machine learning development system of Example 1, wherein the application user interfaces comprise application user interfaces for data processing and feature extraction, training, predictor definitions, visualizations, and data labeling.

Example 3 is the test and measurement machine learning development system of either of Examples 1 and 2, wherein the library of signal processing and feature extraction modules comprise modules for filtering, clock recovery, continuous time linear equalization, de-embedding, measurements, tensor building, spectrograms, and MATLAB feature extraction.

Example 4 is the test and measurement machine learning development system of any of Examples 1 through 3, further comprising a connection to one or more real-time data sources.

Example 5 is the test and measurement machine learning model development system of Example 4, wherein the connection to one or more real-time date sources comprises a REST API.

Example 6 is the test and measurement machine learning development system of any of Examples 1 through 5, wherein the code to cause the one or more processors to receive data from external data sources comprises code to cause the one or more processors to receive data from one or more of a database, cloud storage, a data and waveform simulation tool, stored waveform files, and an acquisition from one or more test and measurement instruments.

Example 7 is the test and measurement machine learning development system of Example 6, wherein the application programming interface includes a query interface to allow the user to search the data.

Example 8 is the test and measurement machine learning development system of any of Examples 1 through 6, wherein the one or more memories comprise a feature store, and wherein the one or more processors are further configured to execute code to cause the one or more processors to store the training data in the feature store.

Example 9 is the test and measurement machine learning development system of any of Examples 1 through 8, wherein the one or more memories comprise a connection to at least one of a cloud storage, a cloud data lake storage, and an embedded database.

Example 10 is the test and measurement machine learning development system of any of Examples 1 through 9, wherein the code to cause the one or more processors to apply one or more machine learning models to the training data comprises code to cause the one or more processors to use a machine learning application programming interface to access one or more machine learning toolkits.

Example 11 is the test and measurement machine learning development system of Example 10, wherein the one or more machine learning toolkits include one or more of TensorFlow, TensorFlow with Keras API, SciKit-Learning, and MATLAB Deep Learning Runtime.

Example 12 is the test and measurement machine learning development system of any of Examples 1 through 11, wherein the code to cause the one or more processors to apply one or more machine learning models to the training data comprises code to cause the one or more processors to apply a machine learning model from a library of one or more saved machine learning models.

Example 13 is the test and measurement machine learning development system of Example 12, wherein the library of one or more saved machine learning models include one or more of a trained machine learning model for performing glitch detection, a trained machine learning model for performing high speed signal classification, a trained machine learning model for performing tuning of optical transceivers, and a trained machine learning model for performing TDECQ measurements.

Example 14 is the test and measurement machine learning development system of either of Examples 12 or 13, wherein the one or more saved machine learning models are files formatted in accordance with the Open Neural Network Exchange (ONNX) standard.

Example 15 is the test and measurement machine learning development system of Example 9, wherein using the machine learning application programming interface to access the one or more machine learning toolkits comprises accessing the one or more machine learning toolkits through a facade layer.

Example 16 is a method for operating a machine learning model development system, the method comprising: displaying, on a user interface, one or more application user interfaces, the application user interfaces allowing a user to provide user inputs; configuring the system based on the user inputs through an application programming interface; receiving data from one or more data sources; applying one or more modules from a library of signal processing and feature extraction modules to the data to produce training data; applying one or more machine learning models to the training data; providing monitoring of the one or more machine learning models; and saving the one or more machine learning models to at least one of one or more memories.

Example 17 is the method of Example 16, wherein configuring the system comprises selecting the one or more modules from the library of signal processing and feature extraction modules to be applied to the data.

Example 18 is the method of either Example 16 or 17, wherein the library of signal processing and feature extraction modules comprise modules for filtering, clock recovery, continuous time linear equalization, de-embedding, measurements, tensor building, spectrograms, and MATLAB feature extraction.

Example 19 is the method of any of Examples 16 through 18, wherein receiving data from the one or more data sources comprises receiving data from at least one of a database, cloud storage, a data and waveform simulation tool, stored waveform files, and an acquisition from one or more test and measurement instruments.

Example 20 is the method of any of Examples 16 through 19, wherein applying one or more machine learning models to the training data comprises using a machine learning application programming interface to access one or more machine learning toolkits.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific embodiments have been illustrated and described for purposes of illustration, it will be understood that various modifications may be made without departing from the spirit and scope of the disclosure. Accordingly, the invention should not be limited except as by the appended claims.

1. A test and measurement machine learning model development system, the system comprising:
a user interface;
one or more ports to allow the system to connect to one or more data sources;
one or more memories; and
one or more processors configured to execute code to cause the one or more processors to:
display on the user interface one or more application user interfaces, the application user interfaces to allow a user to provide user inputs;
use an application programming interface to configure the system based on the user inputs;
receive data from the one or more data sources;
apply one or more modules from a library of signal processing and feature extraction modules to the data to produce training data;
apply one or more machine learning models to the training data;
provide monitoring of the one or more machine learning models; and
save the one or more machine learning models to at least one of the one or more memories.

2. The test and measurement machine learning model development system as claimed in claim 1, wherein the application user interfaces comprise application user interfaces for data processing and feature extraction, training, predictor definitions, visualizations, and data labeling.

3. The test and measurement machine learning model development system as claimed in claim 1, wherein the library of signal processing and feature extraction modules comprise modules for filtering, clock recovery, continuous time linear equalization, de-embedding, measurements, tensor building, spectrograms, and MATLAB feature extraction.

4. The test and measurement machine learning model development system as claimed in claim 1, further comprising a connection to one or more real-time data sources.

5. The test and measurement machine learning model development system as claimed in claim 4, wherein the connection to one or more real-time date sources comprises a REST API.

6. The test and measurement machine learning model development system as claimed in claim 1, wherein the code to cause the one or more processors to receive data from the one or more data sources comprises code to cause the one or more processors to receive data from one or more of a database, cloud storage, a data and waveform simulation tool, stored waveform files, and an acquisition from one or more test and measurement instruments.

7. The test and measurement machine learning model development system as claimed in claim 6, wherein the application programming interface includes a query interface to allow the user to search the data.

8. The test and measurement machine learning model development system as claimed in claim 1, wherein the one or more memories comprise a feature store, and wherein the one or more processors are further configured to execute code to cause the one or more processors to store the training data in the feature store.

9. The test and measurement machine learning model development system as claimed in claim 1, wherein the one or more memories comprise a connection to at least one of a cloud storage, a cloud data lake storage, and an embedded database.

10. The test and measurement machine learning model development system as claimed in claim 1, wherein the code to cause the one or more processors to apply one or more machine learning models to the training data comprises code to cause the one or more processors to use a machine learning application programming interface to access one or more machine learning toolkits.

11. The test and measurement machine learning model development system as claimed in claim 10, wherein the one or more machine learning toolkits include one or more of TensorFlow, TensorFlow with Keras API, SciKit-Learning, and MATLAB Deep Learning Runtime.

12. The test and measurement machine learning model development system as claimed in claim 1, wherein the code to cause the one or more processors to apply one or more machine learning models to the training data comprises code to cause the one or more processors to apply a machine learning model from a library of one or more saved machine learning models.

13. The test and measurement machine learning model development system as claimed in claim 12, wherein the library of one or more saved machine learning models includes one or more of a trained machine learning model for performing glitch detection, a trained machine learning model for performing high speed signal classification, a trained machine learning model for performing tuning of optical transceivers, and a trained machine learning model for performing TDECQ measurements.

14. The test and measurement machine learning model development system as claimed in claim 12, wherein the one or more saved machine learning models are files formatted in accordance with the Open Neural Network Exchange (ONNX) standard.

15. The test and measurement machine learning model development system as claimed in claim 9, wherein using the machine learning application programming interface to access the one or more machine learning toolkits comprises accessing the one or more machine learning toolkits through a facade layer.

16. A method for operating a machine learning model development system, the method comprising:
displaying, on a user interface, one or more application user interfaces, the application user interfaces allowing a user to provide user inputs;
configuring the system based on the user inputs through an application programming interface;
receiving data from one or more data sources;
applying one or more modules from a library of signal processing and feature extraction modules to the data to produce training data;
applying one or more machine learning models to the training data;
providing monitoring of the one or more machine learning models; and
saving the one or more machine learning models to at least one of one or more memories.

17. The method as claimed in claim 16, wherein configuring the system comprises selecting the one or more modules from the library of signal processing and feature extraction modules to be applied to the data.

18. The method as claimed in claim 16, wherein the library of signal processing and feature extraction modules comprise modules for filtering, clock recovery, continuous time linear equalization, de-embedding, measurements, tensor building, spectrograms, and MATLAB feature extraction.

19. The method as claimed in claim 16, wherein receiving data from the one or more data sources comprises receiving data from at least one of a database, cloud storage, a data and waveform simulation tool, stored waveform files, and an acquisition from one or more test and measurement instruments.

20. The method as claimed in claim 16, wherein applying one or more machine learning models to the training data comprises using a machine learning application programming interface to access one or more machine learning toolkits.
